(19) United States
(12) Patent Application Publication
(10) Pub. No.: US 2008/0021966 A1
(43) Pub. Date: Jan. 24, 2008

(54) SYSTEM FOR SENDING ELECTRONIC MAIL

(76) Inventor: Toshio Asami, Tokyo (JP)

Correspondence Address: HOFFMAN, WARNICK & D'ALESSANDRO LLC, 75 STATE ST, 14 FL, ALBANY, NY, 12207, US

(21) Appl. No.: 11/752,967

(22) Filed: May 24, 2007

(30) Foreign Application Priority Data
Jul. 24, 2006 (JP) 2006-200256

(51) Int. Cl. G06F 15/16

(52) U.S. Cl. 709/206

(57) ABSTRACT

The present invention is configured to disclose the electronic mail address of a certain receiver only to another specific receiver selected by a sender when an electronic mail is sent to a plurality of receivers. A system in accordance with an embodiment of the present invention includes: an obtaining unit for obtaining an electronic mail to be sent, in association with a specification of a plurality of destination address groups, at least one of which including a plurality of destinations, and a transmission unit for sending the electronic mail to each of the specified destination address groups, setting destinations included in each of the destination address groups in destination fields to be presented to receivers as destinations, and not setting destinations included in the other destination address groups in the destination fields.

### TECHNICAL FIELD

The present invention relates to systems for sending electronic mail, and in particular, relates to a system for efficiently sending the same electronic mail to a plurality of receivers.

### BACKGROUND ART

In known systems, when a plurality of electronic mail addresses are specified as destinations of an electronic mail, the same electronic mail is sent to the individual destinations. The electronic mail addresses of all of the receivers appear in a destination field in the received electronic mail. FIG. 1 shows a example of such a case. FIG. 1 shows a first example in which an electronic mail is sent. When a sender specifies electronic mail addresses A1, A2, and B1, receivers A1, A2, and B1 receive the same electronic mail. The electronic mail addresses A1, A2, and B1 appear in a TO field in the electronic mail.

However, in some cases, it is unfavorable from the viewpoint of privacy protection that the electronic mail addresses of all receivers are disclosed to the individual receivers. In view of this problem, a method in which a destination list such as a group name is used. In this method, a group name instead of the electronic mail addresses of receivers may appear in a destination field in an electronic mail for the receivers. FIG. 2 shows an example of such a case.

FIG. 2 shows a second example where an electronic mail is sent. The sender associates the electronic mail addresses A1, A2, and B1 with a group name called a group X in advance. Information on the association is managed by, for example, software for sending mail installed in a terminal of the sender. When the sender specifies the group X as a destination, an electronic mail is sent to the electronic mail addresses A1, A2, and B1 corresponding to the group X. Only the name called the group X appears in the electronic mail, and the individual electronic mail addresses corresponding to the group X do not appear.

For a similar purpose, a method in which a BCC field is used is also employed. In this method, nothing appears in a destination field in an electronic mail for the receivers. FIG. 3 shows an example of such a case. In FIG. 3, when the sender specifies the electronic mail addresses A1, B1, and A2 in the BCC field, different electronic mail is sent individually to the electronic mail addresses A1, B1, and A2. In the electronic mail sent to the electronic mail address A1, the electronic mail address A1 appears in the BCC field. In the electronic mail sent to the electronic mail address B1, the electronic mail address B1 appears in the BCC field. In the electronic mail sent to the electronic mail address A2, the electronic mail address A2 appears in the BCC field.

In a technique described in Japanese Unexamined Patent Application Publication No. 2002-244972, destinations can be set, adding another electronic mail address to a pre-registered group or deleting an electronic mail address from the group by using pre-defined operation symbols in a destination field on a screen for creating a mail to be sent. In a technique described in Japanese Unexamined Patent Application Publication No. 2005-018182, when the same electronic mail is sent to a plurality of receivers, different files corresponding to the receivers can be attached. In a technique described in Japanese Unexamined Patent Application Publication No. 2003-6123, when the same electronic mail is sent to a plurality of receivers, control can be performed such that files are attached or not attached depending on the receiver. In a technique described in Japanese Unexamined Patent Application Publication No. 2004-86285, different electronic mail including various types of messages that depend on the names of destinations can be sent all at once.

When the methods described with reference to FIGS. 1 to 3 are used, privacy protection is well supported because one receiver cannot know another receiver. However, when these methods are used, one receiver may forward a received electronic mail to another receiver even though the other receiver has already received the same electronic mail. For example, when an electronic mail is sent to members in an organization from the outside, one receiver may forward the electronic mail so as to share the information in the organization, not knowing that the electronic mail has been already sent to all of the members in the organization. In such a case, the individual receivers may need to perform an unnecessary operation, and an increase in network traffic, an increase in the load on a mail server, and the like may occur.

In any of the above-cited references, although the convenience of receivers can be improved, protection of the privacy of receivers and a reduction in effort cannot be achieved at the same time.

Accordingly, there is a need in the art for a way to solve the aforementioned and other deficiencies of the related art.

### SUMMARY OF THE INVENTION

In an aspect of the present invention, a system for sending an electronic mail is provided. The system includes an obtaining unit for obtaining an electronic mail to be sent, in association with specification of a plurality of destination address groups, at least one of which including a plurality of destinations, and a transmission unit for sending the electronic mail to each of the specified destination address groups, setting destinations included in each of the destination address groups in destination fields to be presented to receivers as destinations, not setting destinations included in the other destination address groups in the destination fields. Moreover, a computer program for causing an information processing unit to function as the system and a method for sending an electronic mail via the system are provided.

In accordance with the present invention, when an electronic mail is sent to a plurality of receivers, an arrangement can be provided, in which the electronic mail address of a certain receiver is disclosed only to another specific receiver selected by a sender.

### BRIEF DESCRIPTION OF THE DRAWINGS

FIG. 1 shows a first example where an electronic mail is sent.

FIG. 2 shows a second example where an electronic mail is sent.

FIG. 3 shows a third example where an electronic mail is sent.

FIG. 4 shows the structure of a communication network in which a communication system 10 and terminal units 40 to 90 are connected.

FIG. 5 shows the functional structure of a terminal unit 20.

FIG. 6 shows the functional structure of a transmission server 30.

FIG. 7 shows an exemplary display on a display unit 200.

FIG. 8 shows an exemplary display on a display unit 400 or 500.

FIG. 9 shows an exemplary display on a display unit 600 or 700.

FIG. 10 shows an exemplary display on a display unit 800.

FIG. 11 shows an exemplary display on a display unit 900.

FIG. 12 shows a flowchart of a process of the communication system 10 sending an electronic mail.

FIG. 13 shows an exemplary display on the display unit 200 in a first modification of an embodiment.

FIG. 14 shows an exemplary display on the display unit 400 or 500 in a first modification of the embodiment.

FIG. 15 shows an exemplary display on the display unit 600 or 700 in the first modification of the embodiment.

FIG. 16(a) shows an exemplary data structure in a group control unit 220 in a second modification of the embodiment. FIG. 16(b) shows an exemplary display on the display unit 200 in the second modification of the embodiment.

FIG. 17 shows the functional structure of the terminal unit 20 in a third modification of the embodiment.

FIG. 18 shows an exemplary hardware configuration of an information processing unit 15 functioning as the terminal unit 20 or the transmission server 30.

### DETAILED DESCRIPTION OF THE INVENTION

The present invention will now be described via an embodiment of the invention. The following embodiment does not restrict the invention defined by the claims. Moreover, all combinations of features described in the embodiment are not necessarily mandatory for the problem-solving means of the invention.

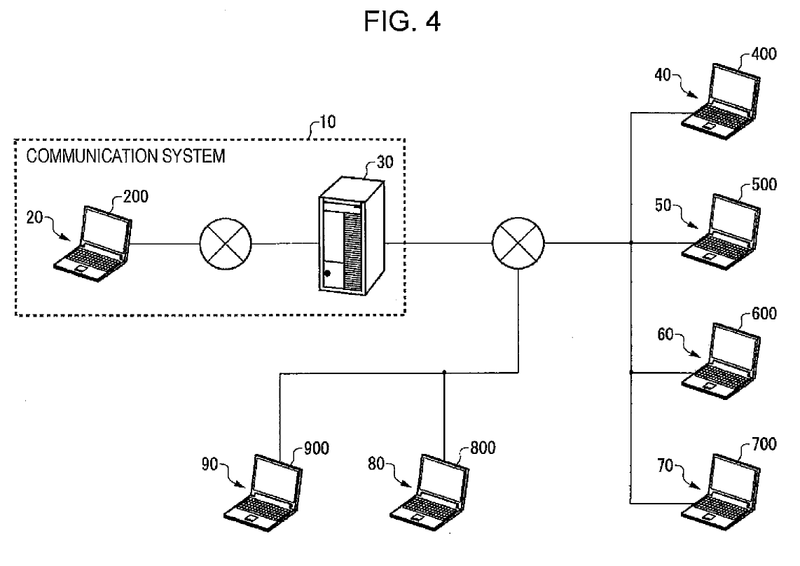

FIG. 4 shows the structure of a communication network in which a communication system 10 and terminal units 40 to 90 are connected. The communication system 10 is, for example, a local area network in a company and includes a terminal unit 20 and a transmission server 30. The terminal unit 20 includes a display unit 200 and displays destination entry fields, a text entry field, and the like on the display unit 200 to receive an entry of an electronic mail from a user. Then, the terminal unit 20 sends the received electronic mail to the transmission server 30. The transmission server 30 is, for example, a server unit that supports communication using the SMTP protocol and transfers the electronic mail received from the terminal unit 20 to another mail server, for example, a receive server that supports communication using the POP protocol, via an appropriate communication path in the communication network. The individual terminal units 40 to 90 are set up, being assigned to different users, receive the electronic mail sent by the transmission server 30 via the receive server, and display the electronic mail on display units 400 to 900, respectively.

An object of the communication system 10 according to the embodiment is to notify only a specific receiver selected by a sender of the electronic mail address of a certain receiver by a function provided in the transmission server 30 when an electronic mail is sent to a plurality of receivers. In this arrangement, unnecessary network traffic due to transfer of electronic mail can be reduced while the privacy of receivers is protected.

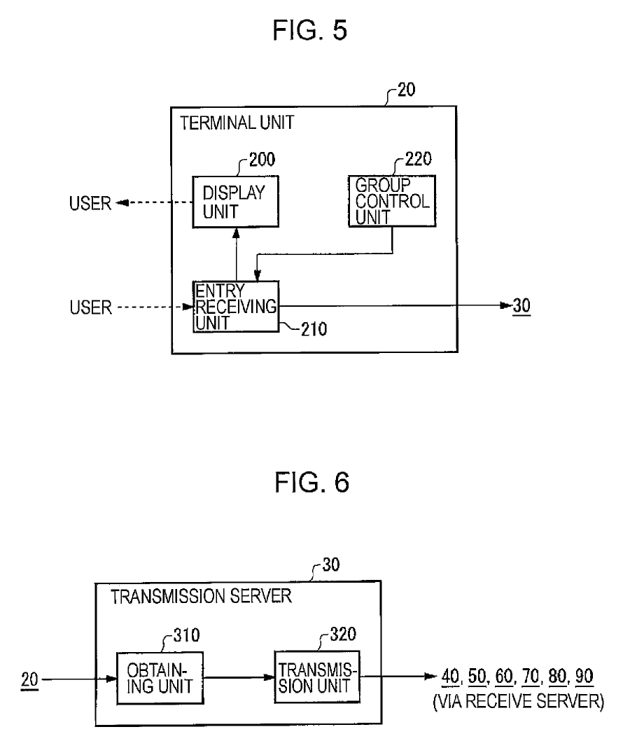

FIG. 5 shows the functional structure of the terminal unit 20. The terminal unit 20 includes the display unit 200, an entry receiving unit 210, and a group control unit 220. The display unit 200 displays a plurality of predetermined destination entry fields for specifying a plurality of destination address groups. The entry receiving unit 210 receives text data indicating destination address groups from a user via the destination entry fields. The entry receiving unit 210 further receives entries of the text and subject of an electronic mail and an attached file from the user. Then, the entry receiving unit 210 sends the received electronic mail to the transmission server 30, in association with the specification of the destination address groups.

An destination address group may be specified using the identifier of a registered address group managed by the group control unit 220. That is to say, for example, the group control unit 220 manages at least one electronic mail address, in association with the identifier of a pre-registered address group. When the user enters text data including the identifier of a registered address group, the entry receiving unit 210 may create an electronic mail and send the electronic mail to the transmission server 30, the destinations of the electronic mail being electronic mail addresses corresponding to the identifier managed by the group control unit 220.

FIG. 6 shows the functional structure of the transmission server 30. The transmission server 30 includes an obtaining unit 310 and a transmission unit 320. The obtaining unit 310 obtains an electronic mail to be sent, which is associated with specification of a plurality of destination address groups, from the terminal unit 20. The transmission unit 320 sends the obtained electronic mail to each of the specified destination address groups via, for example, another mail server. In this case, only destinations included in each of the destination address groups are set in destination fields in the electronic mail to be sent to each of the destination address groups, and destinations included in the other destination address groups are not set in the destination fields. Destinations may be set in destination fields by changing the header of an electronic mail.

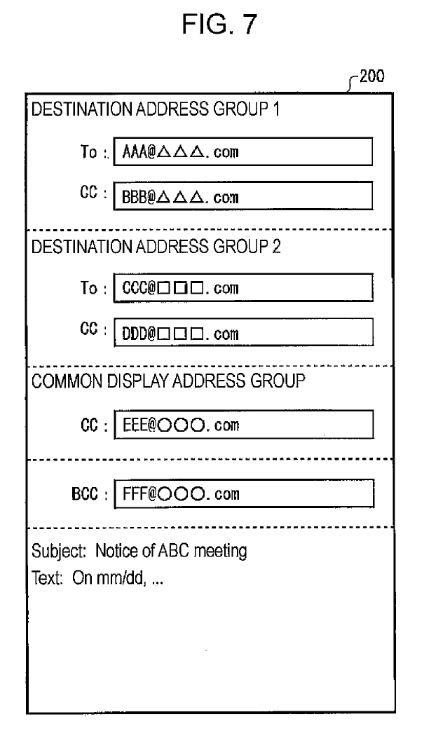

FIG. 7 shows an exemplary display on the display unit 200. The display unit 200 displays a plurality of destination entry fields to receive entries of a plurality of destination address groups. Specifically, the display unit 200 displays a TO: field and a CC: field as destination entry fields of a destination address group 1. The display unit 200 further displays a TO: field and a CC: field as destination entry fields of a destination address group 2. In FIG. 7, the number of destination address groups is two. Alternatively, the display unit 200 may display destination entry fields for more than two destination address groups in response to instructions from the user.

The entry receiving unit 210 receives an entry of an electronic mail address AAA@ΔΔΔ(three triangles).com in one of the destination entry fields of the destination address group 1, for example, the TO: field, and receives an entry of an electronic mail address BBB@ΔΔΔ(three triangles).com in the other destination entry field of the destination address group 1, for example, the CC: field. Similarly, the entry receiving unit 210 receives an entry of an electronic mail address CCC@□□□(three quadrangles).com in one of the destination entry fields of the destination address group 2, for example, the TO: field, and receives an entry of an electronic mail address DDD@□□□(three quadrangles).com in the other destination entry field of the destination address group 2, for example, the CC: field.

When the entry receiving unit 210 accepts an operation to complete entry or a mail sending operation, the entry receiving unit 210 determines that a set of the electronic mail addresses AAA@ΔΔΔ(three triangles).com and BBB@ΔΔΔ(three triangles).com is specified for the destination address group 1. The entry receiving unit 210 further determines that a set of the electronic mail addresses CCC@□□□(three quadrangles).com and DDD@□□□(three quadrangles).com is specified for the destination address group 2. Then, the entry receiving unit 210 sends the specification of the destination address group 1 and the destination address group 2 to the obtaining unit 310 in the transmission server 30, the specification being in association with the subject, text, and the like of an electronic mail. In this arrangement, the obtaining unit 310 can obtain, as the specification of each of the destination address groups, one or more electronic mail addresses entered in the destination entry fields corresponding to each of the destination address groups.

The display unit 200 may further display a common-display-address-group entry field for entering specification of a common display address group. A common display address group is a group of destinations to be commonly displayed in a destination field in an electronic mail to be sent to each of the destination address groups. In FIG. 7, the entry receiving unit 210 receives an entry of an electronic mail address EEE@◯◯◯(three circles).com in a common-display-address-group entry field. In this case, the entry receiving unit 210 determines that the electronic mail address EEE@◯◯◯(three circles).com is specified for a common display address group. The entry receiving unit 210 sends the text and the like of the electronic mail to the transmission server 30 in response to, for example, instructions to complete entry, further in association with the specification of the common group. In this arrangement, the obtaining unit 310 can obtain an electronic mail that is further associated with specification of a common display address group.

The display unit 200 may further display a BCC: field, as in an ordinary electronic mail. In FIG. 7, the entry receiving unit 210 receives an entry of an electronic mail address FFF@◯◯◯(three circles).com in a BCC: field. The entry receiving unit 210 sends the text and the like of the electronic mail to the transmission server 30 in response to, for example, instructions to complete entry, further in association with the electronic mail address FFF@◯◯◯(three circles).com entered in the BCC: field.

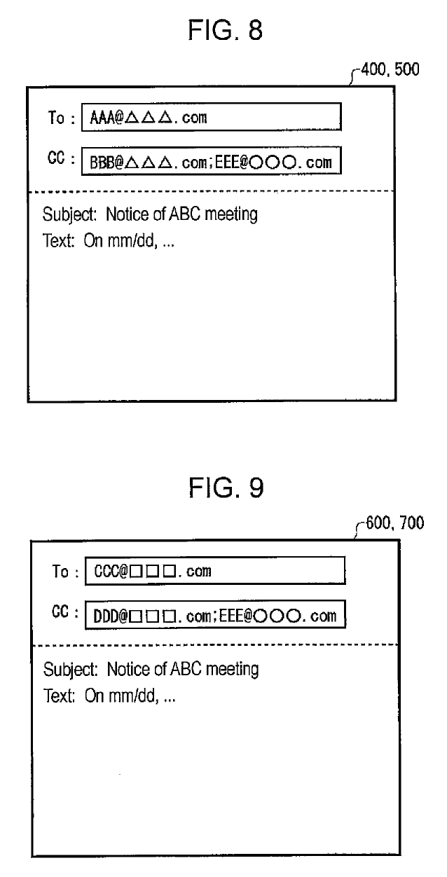

It will now be described with reference to FIGS. 8 to 11 how such an electronic mail is presented to receivers. In the following description, it is assumed that an electronic mail for the electronic mail address AAA@ΔΔΔ(three triangles).com is received in the terminal unit 40, and an electronic mail for the electronic mail address BBB@ΔΔΔ(three triangles).com is received in the terminal unit 50. Moreover, it is assumed that an electronic mail for the electronic mail address CCC@□□□(three quadrangles).com is received in the terminal unit 60, and an electronic mail for the electronic mail address DDD@□□□(three quadrangles).com is received in the terminal unit 70. Moreover, it is assumed that an electronic mail for the electronic mail address EEE@◯◯◯(three circles).com is received in the terminal unit 80, and an electronic mail for the electronic mail address FFF@◯◯◯(three circles).com is received in the terminal unit 90.

FIG. 8 shows an exemplary display on the display unit 400 or 500. The exemplary display on the display unit 400 out of these display units will be described. The display unit 400 displays the electronic mail address AAA@ΔΔΔ(three triangles).com in a TO: field that is a destination field in a received electronic mail. The display unit 400 further displays the electronic mail address BBB@ΔΔΔ(three triangles).com in a CC: field that is a destination field in the received electronic mail. The electronic mail addresses CCC@□□□(three quadrangles).com and DDD@□□□(three quadrangles).com included in another destination address group other than these electronic mail addresses do not appear in these destination fields. The display unit 400 further displays the electronic mail address EEE@◯◯◯(three circles).com included in the common display address group. The display unit 400 further displays the subject and text of the electronic mail. Since the exemplary display on the display unit 500 is substantially the same as the exemplary display on the display unit 400, the description of the exemplary display on the display unit 500 is omitted.

FIG. 9 shows an exemplary display on the display unit 600 or 700. The exemplary display on the display unit 600 out of these display units will be described. The display unit 600 displays the electronic mail address CCC@□□□(three quadrangles).com in a TO: field that is a destination field in a received electronic mail. The display unit 600 further displays the electronic mail address DDD@□□□(three quadrangles).com in a CC: field that is a destination field in the received electronic mail. The electronic mail addresses AAA@ΔΔΔ(three triangles).com and BBB@ΔΔΔ(three triangles).com included in another destination address group other than these electronic mail addresses do not appear in these destination fields. The display unit 600 further displays the electronic mail address EEE@◯◯◯(three circles).com included in the common display address group. The display unit 600 further displays the subject and text of the electronic mail. Since the exemplary display on the display unit 700 is substantially the same as the exemplary display on the display unit 600, the description of the exemplary display on the display unit 700 is omitted.

A destination field in the embodiment is not limited to a TO field or a CC field included in the header of an electronic mail address. For example, when a destination, together with a character string indicating a destination, is shown in the text of an electronic mail, an area for displaying the character string is also a destination field. That is to say, the transmission unit 320 may send an electronic mail to each of the destination address groups, setting destinations included in each of the destination address groups in an area for displaying a destination associated with a character string indicating a destination in the text of the electronic mail, not setting destinations included in the other destination address group in the area. Even when such a function is provided, the privacy of receivers can be protected by combining this function with an existing function of completely suppressing display of destinations of an electronic mail while the convenience of a sender is maintained.

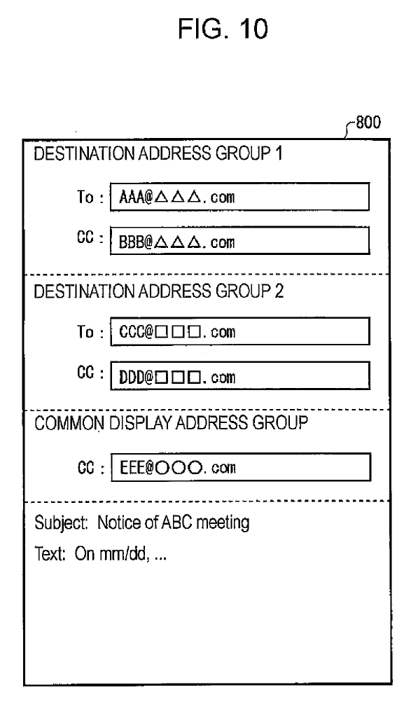

FIG. 10 shows an exemplary display on the display unit 800. In an electronic mail sent to the receiver (the electronic mail address is EEE@◯◯◯(three circles).com) included in the common display address group, all of the destination address groups specified by the sender excluding the destination specified in the BCC: field are displayed. Since the content displayed in the individual destination fields is the same as the content entered in the entry fields for an electronic mail to be sent shown in FIG. 7, the description of the content displayed in the individual destination fields is omitted.

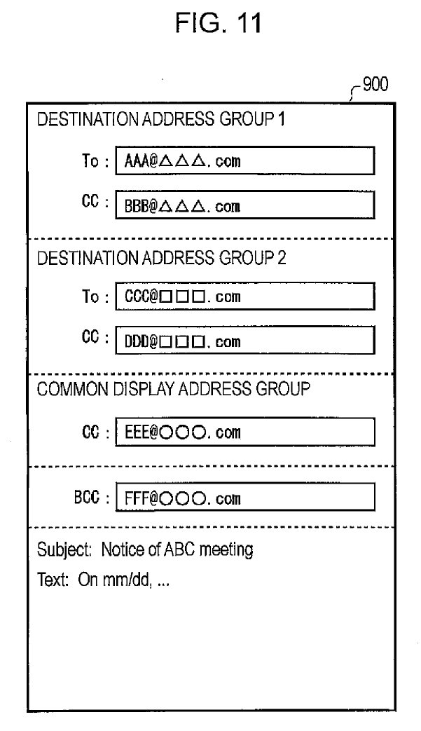

FIG. 11 shows an exemplary display on the display unit 900. In an electronic mail sent to the receiver (the electronic mail address is FFF@◯◯◯(three circles).com) specified in the BCC: entry field, the display unit 900 displays all of the destinations designated to be displayed in the destination fields in the destination fields. Since the content displayed in the individual destination fields is the same as the content entered in the entry fields for an electronic mail to be sent shown in FIG. 7, the description of the content displayed in the individual destination fields is omitted. The display unit 900 further displays the electronic mail address FFF@◯◯◯(three circles).com of the receiver in a BCC: field and displays the subject and text of the electronic mail.

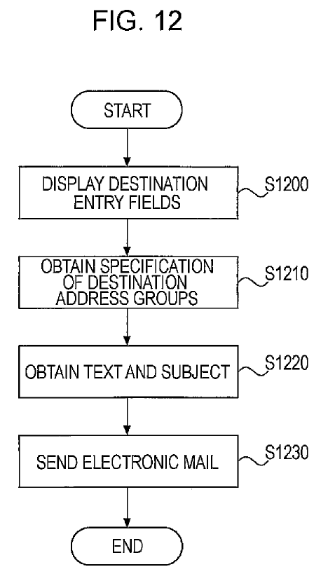

FIG. 12 shows a flowchart of a process of the communication system 10 sending an electronic mail. The display unit 200 displays a plurality of destination entry fields to receive entries of a plurality of destination address groups (S1200). The display unit 200 may further receive entries of a common display address group and a destination of BCC:. The obtaining unit 310 obtains an electronic mail to be sent, in association with specification of the plurality of destination address groups, at least one of which including a plurality of destinations, and specification of the common display address group (S1210).

As another example, the obtaining unit 310 may merely obtain a plurality of electronic mail addresses and automatically classify the electronic mail addresses into a plurality of destination address groups. That is to say, for example, the obtaining unit 310 may classify a plurality of electronic mail addresses obtained as specification of destination address groups into a plurality of groups for individual domain names of the electronic mail addresses and determine each of the classified groups as being a destination address group.

The obtaining unit 310 also obtains the text, subject, and the like of the electronic mail, an attached file, and the like (S1220). The transmission unit 320 performs the following operation to send the electronic mail (S1230). For each of the specified destination address groups, the transmission unit 320 first generates an electronic mail. In the electronic mail, destinations included in each of the destination address groups are set in destination fields to be presented to receivers as destinations, and destinations included in the other destination address groups are not set in the destination fields. Then, the transmission unit 320 adds the destinations included in the common display address to the destination fields in each electronic mail to be sent to each of the destination address groups. Then, the transmission unit 320 transfers these electronic mails to another mail server to send the corresponding electronic mail to each of the destination address groups.

In the communication system 10 according to an embodiment, when an electronic mail is sent to a plurality of receivers, the electronic mail addresses of receivers included in a certain destination address group can be presented only to the other receivers included in the destination address group, and not to receivers included in the other destination address groups. In this arrangement, while the privacy of receivers is protected, unnecessary transfer of electronic mails by receivers can be prevented, and network traffic, the processing load on a server, and the like can be reduced. Moreover, a common display address group can be specified so that an electronic mail address that can be presented to any receiver can be specified, and a flexible control of display of destination fields can be performed by a simplified operation.

First and second modifications of the embodiment will now be described.

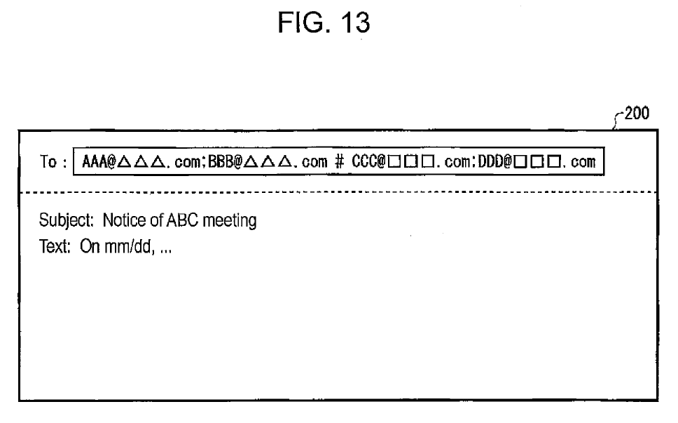

FIG. 13 shows an exemplary display on the display unit 200 in a first modification of the embodiment. The display unit 200 displays a destination entry field for specifying destination address groups, as in the example of, e.g., FIG. 7. However, unlike the example of, e.g., FIG. 7, the entry receiving unit 210 accepts entries of not only an address separator “;” that is a delimiter between electronic mail addresses but also a predetermined group separator “#” that is different from an address separator in text data obtained as specification of destination address groups. Upon obtaining text data including these separators, the obtaining unit 310 determines each of a plurality of set of electronic mails separated from each other with a group separator as being a destination address group on the condition that the listed electronic mail addresses are separated from each other with the group separator. That is to say, the obtaining unit 310 determines that a set of the electronic mail addresses AAA@ΔΔΔ(three triangles).com and BBB@ΔΔΔ(three triangles).com is one destination address group, and a set of the electronic mail addresses CCC@□□□(three quadrangles).com and DDD@□□□(three quadrangles).com is the other destination address group. Then, the transmission unit 320 sends an electronic mail to each of these destination address groups, setting destinations included in each of the destination address groups in a destination field to be presented to receivers as a destination, not setting destinations included in the other destination address group in the destination field.

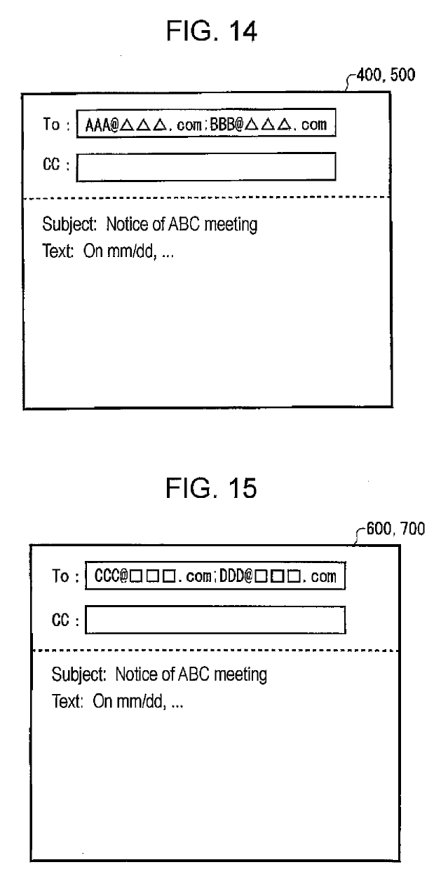

FIG. 14 shows an exemplary display on the display unit 400 or 500 in the first modification of the embodiment. When the electronic mail shown in FIG. 13 is sent, in a destination field in the received electronic mail, the display unit 400 displays individual electronic mail addresses in the same destination address group as that of the receiver and does not display the electronic mail addresses of receivers in the other destination address groups. That is to say, the display unit 400 displays the set of the electronic mail addresses AAA@ΔΔΔ(three triangles).com and BBB@ΔΔΔ(three triangles).com and does not display the set of the electronic mail addresses CCC@□□□(three quadrangles).com and DDD@□□□(three quadrangles).com. Since a display that is substantially the same as that on the display unit 400 appears on the display unit 500, the description of the display on the display unit 500 is omitted.

FIG. 15 shows an exemplary display on the display unit 600 or 700 in the first modification of the embodiment. When the electronic mail shown in FIG. 13 is sent, the display unit 600 displays the set of the electronic mail addresses CCC@□□□(three quadrangles).com and DDD@□□□(three quadrangles).com and does not display the set of the electronic mail addresses AAA@ΔΔΔ(three triangles).com and BBB@ΔΔΔ(three triangles).com. Since a display that is substantially the same as that on the display unit 600 appears on the display unit 700, the description of the display on the display unit 700 is omitted.

In the first modification, destination address groups can be specified with an address separator. Thus, some users can readily specify destination address groups, and the number of destination entry fields displayed on the screen of the display unit 200 can be reduced, so that the screen layout is simplified, and a necessary display area on the screen can be reduced.

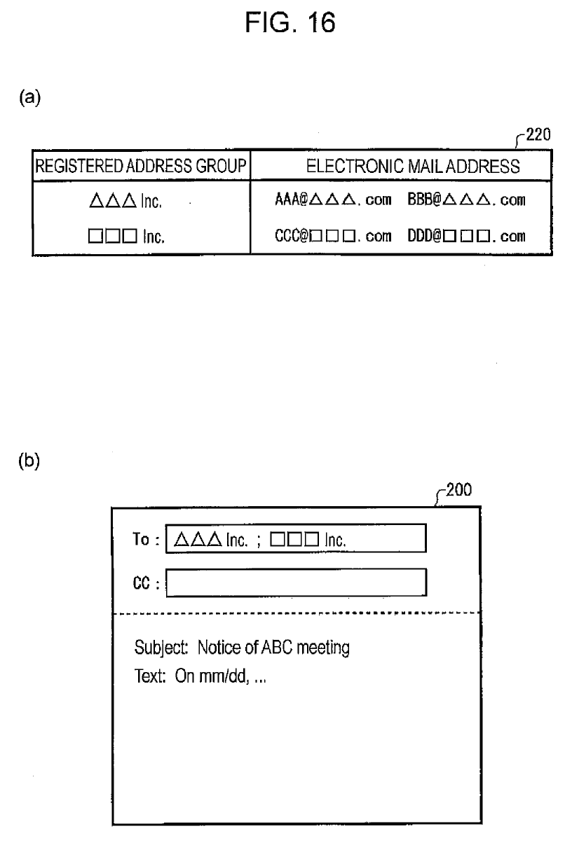

FIG. 16(a) shows an exemplary data structure in the group control unit 220 in a second modification of the embodiment. In this modification, the group control unit 220 manages the electronic mail addresses AAA@ΔΔΔ(three triangles).com and BBB@ΔΔΔ(three triangles).com, in association with ΔΔΔ(three triangles) Inc. that is the identifier of a registered address group that is registered in advance. The group control unit 220 further manages the electronic mail addresses CCC@□□□(three quadrangles).com and DDD@□□□(three quadrangles).com, in association with □□□(three quadrangles) Inc. that is the identifier of a registered address group that is registered in advance.

FIG. 16(b) shows an exemplary display on the display unit 200 in the second modification of the embodiment. The display unit 200 allows entry of the identifier of a registered address group in a destination entry field that is displayed for allowing specification of a destination address group. When the obtaining unit 310 obtains text data entered in a destination entry field, the obtaining unit 310 determines whether the text data includes the identifier of any registered address group.

On the condition that the text data includes the identifier of a registered address group, the obtaining unit 310 determines that a set of electronic mail addresses that are managed in association with the identifier of the registered address group are in the same destination address group. Thus, the obtaining unit 310 determines that the electronic mail addresses AAA@ΔΔΔ(three triangles).com and BBB@ΔΔΔ(three triangles).com corresponding to ΔΔΔ(three triangles) Inc. constitute one destination address group, and the electronic mail addresses CCC@□□□(three quadrangles).com and DDD@□□□(three quadrangles).com corresponding to □□□(three quadrangles) Inc. constitute another destination address group. Accordingly, the transmission unit 320 sends an electronic mail to each of these destination address groups, setting destinations included in each of the destination address groups in destination fields to be presented to receivers as destinations, not setting destinations included in the other destination address group in the destination fields. Since the screens that appear on the display units 400, 500, 600, and 700 as the result are the same as those in the first modification, the description of the screens is omitted.

In text data indicating destinations, the identifier of a registered address group and ordinary electronic mail addresses can be mixed. In this case, the obtaining unit 310 determines that a set of electronic mail addresses that are managed in association with the identifier are included in the same destination address group, and the ordinary electronic mail addresses included in the text data are included in the other destination address groups. In this arrangement, the user can specify destination address groups more flexibly.

In the second modification, destination address groups can be specified by yet another method. Thus, the convenience of the user can be improved.

A third modification will now be described. Unlike the structures shown in FIGS. 5 and 6, in the third modification, the terminal unit 20 instead of the transmission server 30 has a function of setting destinations of electronic mails. In this arrangement, the cost, period, and the like that are necessary to implement the embodiment are reduced by providing new functions only in the terminal unit 20 and using an existing mail server as the transmission server 30.

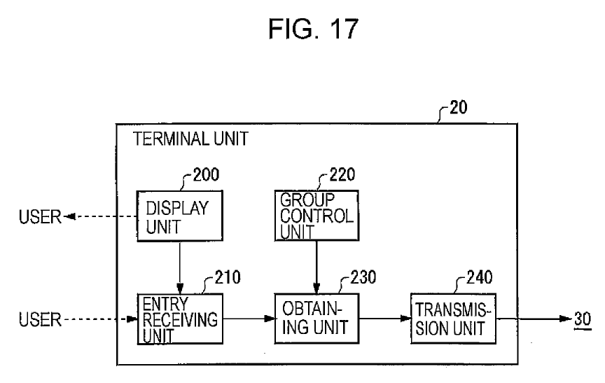

FIG. 17 shows the functional structure of the terminal unit 20 in the third modification of the embodiment. The terminal unit 20 includes the display unit 200, the entry receiving unit 210, the group control unit 220, an obtaining unit 230, and a transmission unit 240. The display unit 200 is similar to the display unit 200, which has been already described, and displays destination entry fields for specifying destination address groups. The entry receiving unit 210 receives entries of specification of destination address groups. The obtaining unit 230 obtains an electronic mail, in association with the specification of the destination address groups. When a registered address group is entered as specification of a destination address group, the group control unit 220 outputs electronic mail addresses corresponding to the registered address group to the obtaining unit 230. The transmission unit 240 sends an electronic mail to each of the destination address groups, setting destinations included in each of the destination address groups in destination fields, not setting destinations included in the other destination address groups in the destination fields.

In the third modification, destination fields are set by the terminal unit 20. Thus, even when an existing mail server is used as the transmission server 30, the functions according to the embodiment can be implemented.

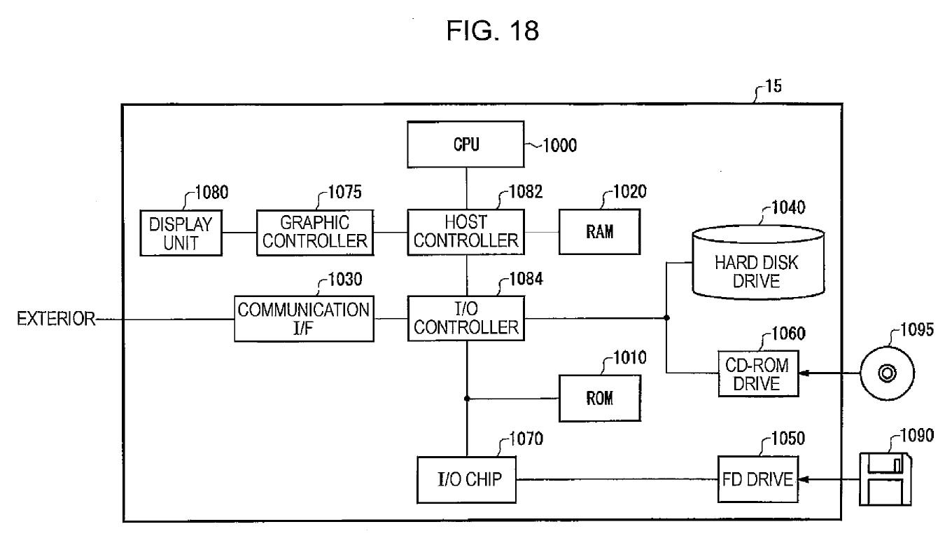

FIG. 18 shows an exemplary hardware configuration of an information processing unit 15 functioning as the terminal unit 20 or the transmission server 30. The information processing unit 15 includes a CPU peripheral section that includes a CPU 1000, a RAM 1020, and a graphic controller 1075 that are connected to each other via a host controller 1082, an input-output section that includes a communication interface 1030, a hard disk drive 1040, and a CD-ROM drive 1060 that are connected to the host controller 1082 via an input-output controller 1084, and a legacy input-output section that includes a ROM 1010, a flexible disk drive 1050, and an input-output chip 1070 that are connected to the input-output controller 1084.

The host controller 1082 connects the RAM 1020 to the CPU 1000 and the graphic controller 1075, which access the RAM 1020 at a high transfer rate. The CPU 1000 operates according to computer programs stored in the ROM 1010 and the RAM 1020 and controls individual components. The graphic controller 1075 obtains image data generated in a frame buffer provided in the RAM 1020 by the CPU 1000 and the like and displays the image data on a display unit 1080. Instead of this arrangement, the graphic controller 1075 may include the frame buffer, which stores image data generated by the CPU 1000 and the like.

The input-output controller 1084 connects the host controller 1082 to the communication interface 1030, the hard disk drive 1040, and the CD-ROM drive 1060, which are relatively high-speed input-output units. The communication interface 1030 communicates with external devices via networks. The hard disk drive 1040 stores computer programs and data used by the information processing unit 15. The CD-ROM drive 1060 reads computer programs or data from a CD-ROM 1095 and supplies the programs or data to the RAM 1020 or the hard disk drive 1040.

Moreover, the ROM 1010, the flexible disk drive 1050, the input-output chip 1070, and the like, which are relatively low-speed input-output units, are connected to the input-output controller 1084. The ROM 1010 stores a boot program executed by the CPU 1000 when the information processing unit 15 is activated, programs that depend on the hardware of the information processing unit 15, and the like. The flexible disk drive 1050 reads programs or data from a flexible disk 1090 and supplies the programs or data to the RAM 1020 or the hard disk drive 1040 via the input-output chip 1070. The input-output chip 1070 enables connection of the flexible disk 1090, various types of input-output unit via, for example, a parallel port, a serial port, a keyboard port, and a mouse port, and the like.

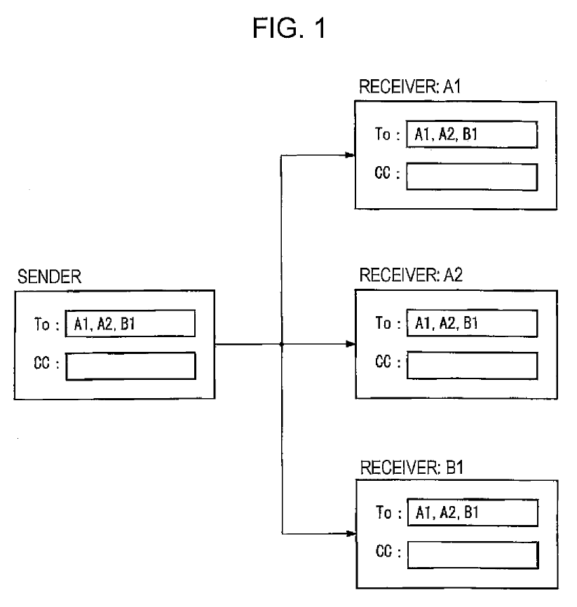

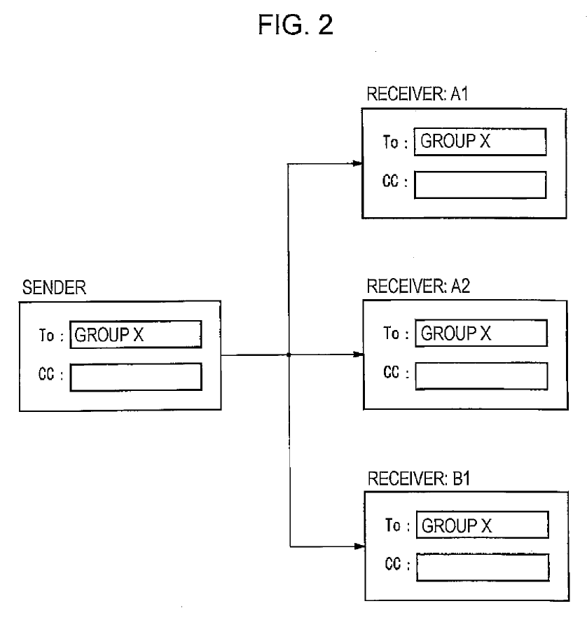

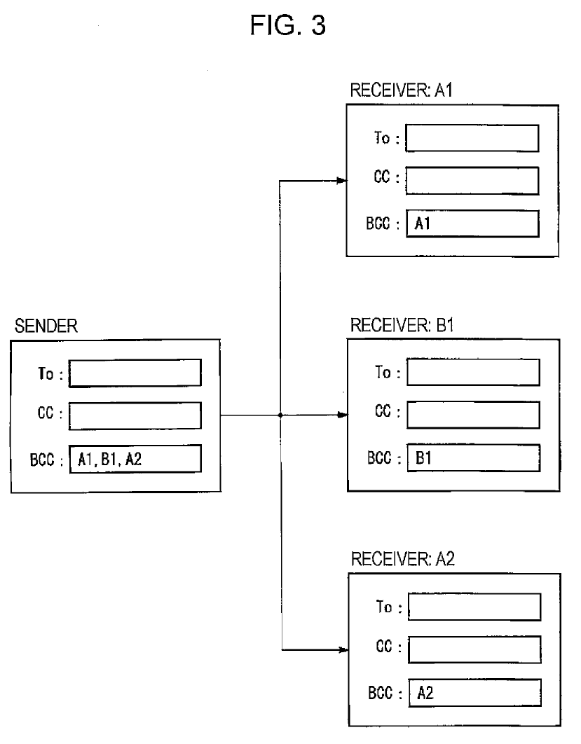

Programs provided to the information processing unit 15 are stored in a recording medium, such as the flexible disk 1090, the CD-ROM 1095, or an IC card, and provided by the user. The programs are read from the recording medium via the input-output chip 1070 and/or the input-output controller 1084, and installed and executed in the information processing unit 15. Operations performed by the information processing unit 15 and the like driven by the programs are the same as the operations in the terminal unit 20 or the transmission server 30 described in FIGS. 1 to 17, and thus the description of the operations is omitted.

The aforementioned programs may be stored in an external storage medium. In addition to the flexible disk 1090 and the CD-ROM 1095, an optical recording medium such as a DVD or a PD, a magneto-optical recording medium such as an MD, a tape medium, a semiconductor memory such as an IC card, or the like can be used as the storage medium. Moreover, the programs may be provided to the information processing unit 15 via networks using, as the recording medium, a storage unit, such as a hard disk or a RAM, provided in a server system connected to a private communication network, the Internet, or the like.

While the present invention has been described via the embodiment, the technical scope of the present invention is not limited to the scope described in the foregoing embodiment. It is apparent to those skilled in the art that various changes or improvements can be made in the foregoing embodiment. It is apparent from the description in the claims that the embodiment that is changed or improved may be included in the technical scope of the present invention.

1. A system for sending an electronic mail, comprising:
an obtaining unit for obtaining an electronic mail to be sent, in association with a specification of a plurality of destination address groups, at least one of which including a plurality of destinations; and
a transmission unit for sending the electronic mail to each of the specified destination address groups, setting destinations included in each of the destination address groups in destination fields to be presented to receivers as destinations, and not setting destinations included in the other destination address groups in the destination fields.

2. The system according to claim 1, wherein the obtaining unit obtains the electronic mail, further in association with a specification of a common display address group that includes destinations to be commonly displayed in destination fields in each electronic mail to be sent to each of the destination address groups, and
the transmission unit sends the electronic mail to each of the destination address groups, further adding the destinations included in the common display address group to the destination fields.

3. The system according to claim 1, further comprising:
a display unit for displaying a plurality of predetermined destination entry fields for specifying a plurality of destination address groups, wherein
the obtaining unit obtains, as a specification of each of the destination address groups, one or more electronic mail addresses entered in destination entry fields for each of the destination address groups.

4. The system according to claim 1, wherein, on a condition that a plurality of electronic mail addresses listed in text data obtained as a specification of destination address groups are separated from each other with a predetermined group separator that is different from an address separator that is a delimiter between electronic mail addresses, the obtaining unit determines that each of a plurality of set of the electronic mail addresses separated from each other with the group separator is a destination address group.

5. The system according to claim 1, further comprising:
a group control unit for managing at least one electronic mail address in association with an identifier of a registered address group that is registered in advance, wherein,
on a condition that an identifier of a registered address group is included in text data obtained as a specification of destination address groups, the obtaining unit determines that a set of electronic mail addresses that are managed in association with the identifier of the registered address group are included in the same destination address group.

6. The system according to claim 1, wherein the obtaining unit classifies a plurality of electronic mail addresses obtained as a specification of destination address groups into a plurality of groups for individual domain names of the electronic mail addresses and obtains each of the classified groups as a destination address group.

7. The system according to claim 1, further comprising:
a terminal unit and a transmission server for transferring an electronic mail received from the terminal unit to another mail server, wherein,
in the terminal unit,
the obtaining unit obtains the electronic mail created by a user, in association with specification of destination address groups, and
the transmission unit generates an electronic mail, for each of the specified destination address groups, in which destinations included in each of the destination address groups are set in destination fields to be presented to receivers as destinations, and destinations included in the other destination address groups are not set in the destination fields, and sends the electronic mail to the transmission server.

8. The system according to claim 1, further comprising:
a terminal unit and a transmission server for transferring an electronic mail received from the terminal unit to another mail server, wherein,
in the transmission server,
the obtaining unit obtains the electronic mail from the terminal unit, in association with a specification of destination address groups, and
the transmission unit generates an electronic mail, for each of the specified destination address groups, in which destinations included in each of the destination address groups are set in destination fields to be presented to receivers as destinations, and destinations included in the other destination address groups are not set in the destination fields, and sends the electronic mail to the other mail server.

9. A method for sending an electronic mail, comprising:
obtaining an electronic mail to be sent, in association with a specification of a plurality of destination address groups, at least one of which including a plurality of destinations; and
sending the electronic mail to each of the specified destination address groups, setting destinations included in each of the destination address groups in destination fields to be presented to receivers as destinations, and not setting destinations included in the other destination address groups in the destination fields.

10. The method according to claim 9, wherein the electronic mail is obtained, further in association with a specification of a common display address group that includes destinations to be commonly displayed in destination fields in each electronic mail to be sent to each of the destination address groups, and wherein the electronic mail is sent to each of the destination address groups with the destinations included in the common display address group added to the destination fields.

11. The method according to claim 9, further comprising:
displaying a plurality of predetermined destination entry fields for specifying a plurality of destination address groups; and
obtaining as a specification of each of the destination address groups, one or more electronic mail addresses entered in destination entry fields for each of the destination address groups.

12. The method according to claim 9, wherein, on a condition that a plurality of electronic mail addresses listed in text data obtained as a specification of destination address groups are separated from each other with a predetermined group separator that is different from an address separator that is a delimiter between electronic mail addresses, determining that each of a plurality of set of the electronic mail addresses separated from each other with the group separator is a destination address group.

13. The method according to claim 9, further comprising:
managing at least one electronic mail address in association with an identifier of a registered address group that is registered in advance, wherein,
on a condition that an identifier of a registered address group is included in text data obtained as a specification of destination address groups, determining that a set of electronic mail addresses that are managed in association with the identifier of the registered address group are included in the same destination address group.

14. The method according to claim 9, further comprising:
classifying a plurality of electronic mail addresses obtained as a specification of destination address groups into a plurality of groups for individual domain names of the electronic mail addresses and obtaining each of the classified groups as a destination address group.

15. A program product stored on a computer readable medium, which when executed, causes an information processing unit to function as a system for sending an electronic mail, the computer readable medium comprising program code for:
obtaining an electronic mail to be sent, in association with a specification of a plurality of destination address groups, at least one of which including a plurality of destinations; and
sending the electronic mail to each of the specified destination address groups, setting destinations included in each of the destination address groups in destination fields to be presented to receivers as destinations, and not setting destinations included in the other destination address groups in the destination fields.
